(19) United States
(12) Patent Application Publication
(10) Pub. No.: US 2014/0295164 A1
(43) Pub. Date: Oct. 2, 2014

(54) WATER RESISTANT LOW FLAME-SPREAD INTUMESCENT FIRE RETARDANT COATING

(71) Applicant: WEYERHAEUSER NR COMPANY, Federal Way, WA (US)

(72) Inventors: Erik M. Parker, Meridian, ID (US); Jack G. Winterowd, Puyallup, WA (US); Glen Robak, Meridian, ID (US)

(73) Assignee: WEYERHAEUSER NR COMPANY, FEDERAL WAY, WA (US)

(21) Appl. No.: 13/851,898

(22) Filed: Mar. 27, 2013

(51) Int. Cl. C09K 21/06

(52) U.S. Cl. CPC C09K 21/06
USPC 428/221; 252/602; 428/425.1

(57) ABSTRACT

The present disclosure provides compositions formulated to provide water resistant and low flame spread properties when applied as a coating to a surface (e.g., the surface of a wood product). Wood products treated with the composition, as well as methods for applying the composition to a surface are also provided.

### BACKGROUND

One way to improve the fire-safety of buildings is to follow construction guidelines for fire prevention and damage mitigation, which include detailed recommendations regarding structural design, assemblies, sprinkler systems, smoke detectors, and other factors influencing how a fire might start and spread throughout a building. In addition, companies that manufacture building materials from wood have taken steps to make their products inherently more fire-safe. Some companies have experimented with coating or impregnating wood products with fire-retardant chemical treatments. Examples of such treatments are described in U.S. Pat. Nos. 6,245,842 and 5,968,669, the disclosures of which are hereby incorporated by reference in their entirety.

For wood products used in construction there are two main tests used to qualify wood products as fire-resistant materials in the building codes. The first test is the ASTM E119 fire endurance test, which measures the ability of the product to maintain its load bearing capacity during a fire. The second test is the ASTM E2768 surface burning test (flame spread), which requires a 30-minute burn on an ASTM E84 surface burning test set-up. The E2768 test measures the ability of the material to resist or slow the propagation of a flame along its surface. Coatings that perform well in one of these tests do not necessarily perform well in the other. For example, a coating that is relatively non-combustible may prevent the spread of a flame along its surface, but may do very little to protect the substrate from heat degradation. Such a coating would perform well in the E84 test but perform poorly in an E119 test. Conversely, a coating that rapidly expands when exposed to heat or flame may not prevent a flame from traveling along its surface.

In the interest of greater fire safety, there is a need in the construction industry to develop improved coatings for wood products that enhance fire endurance properties, as well as slow the propagation of flame along its surface.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

In one aspect, a composition having water resistance and low flame-spread is provided. In one embodiment, the composition includes: a latex binder; a borate compound; intumescent particles; and an isocyanate.

In another aspect, a wood product having water resistance and low flame spread is provided. In one embodiment, the wood product includes: a wood element having at least one surface; and a composition as disclosed herein disposed on at least a portion of the at least one surface.

Further aspects include methods for applying the composition (e.g., as a coating on a surface of a wood product).

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIGS. 1 and 2 are side cross sectional views of I-joists coated with a composition according to embodiments of the disclosure; and

FIGS. 3 and 4 are side cross sectional views of wood products coated with a composition according to embodiments of the disclosure.

### DETAILED DESCRIPTION

The present disclosure describes compositions formulated to provide water resistant and low flame spread properties when applied as a coating to a surface (e.g., the surface of a wood product).

In one aspect, a composition having water resistance and low flame-spread is provided. In one embodiment, the composition includes: a latex binder; a borate compound; intumescent particles; and an isocyanate.

In another aspect, a wood product having water resistance and low flame spread is provided. In one embodiment, the wood product includes: a wood element having at least one surface; and a composition as disclosed herein disposed on at least a portion of the at least one surface.

Well-known structures, systems, and methods often associated with such systems have not been shown or described in detail to avoid unnecessarily obscuring the description of various embodiments of the disclosure. In addition, those of ordinary skill in the relevant art will understand that additional embodiments of the disclosure may be practiced without several of the details described below. Certain terminology used in the disclosure is defined as follows.

“Wood product” is used to refer to a product manufactured from logs, such as lumber (e.g., boards, dimension lumber, solid sawn lumber, joists, headers, beams, timbers, mouldings, laminated, finger jointed, or semi-finished lumber), composite wood products, or components of any of the aforementioned examples. The term “wood element” is also used to refer to any type of wood product.

“Composite wood product” is used to refer to a range of derivative wood products which are manufactured by binding together the strands, particles, fibers, or veneers of wood, together with adhesives, to form composite materials. Examples of composite wood products include but are not limited to glulam, plywood, parallel strand lumber (PSL), oriented strand board (OSB), oriented strand lumber (OSL), laminated veneer lumber (LVL), laminated strand lumber (LSL), particleboard, medium density fiberboard (MDF) and hardboard.

“Intumescent particles” refer to materials that expand in volume when they are exposed to elevated temperatures (e.g., fire).

When applied to wood products, the provided compositions provide water resistance. As used herein, the term “water resistance” refers to a treated state of the wood product wherein the wood product passes a “24-hour water soak test” as described in the EXAMPLES below. Briefly, the coated wooden specimen is submerged in water for 24-hours. The coating must adhere to the substrate and should be difficult to rub off when wet. This test is performed because wood products are often stored outdoors and the coating must still perform after weeks or months of storage (sometimes called “yardability”). In addition to this, in order to pass certain code requirements, the coating must undergo durability testing and still be able to pass the E2768 (30 min) test, which is discussed elsewhere herein.

When applied to wood products, the provided compositions also provide low flame-spread properties. As used herein, the term “low flame-spread” refers to a treated state of the wood product wherein the wood product is rated at least Class A (10 minute burn) using the E84 surface burning test. In certain embodiments, the composition provides Fire-retardant-treated wood (International Building code Section 2303.2) qualification based on the E2768 (30 minute burn) surface burning test.

A flame-spread index is determined in the E84 test. The building code classifies the flame-spread index into classes. There are A, B and C flame spread ratings. The building code also allows for the use of fire-retardant-treated wood. Fire-retardant-treated wood also utilizes ASTM E84 but requires the specimen to be tested with an additional 20-minute period. ASTM E2768 was created with this additional 20-minute period in mind to evaluate the ability of a product to limit the surface spread of flame when evaluated for 30 minutes (10 min. plus 20 min.). The provided composition as a coating on a wood product is designed to meet the Class A flame spread with the additional 20 minute extension so that it can be equivalent to fire retardant treated wood. For class A, the flame front cannot travel more than 10.5 feet in a 10 minute period. For the 20 minute extension the flame front still cannot travel past 10.5 feet for the total 30 minutes.

The components of the provided compositions will now be described. Unless noted otherwise, the percentages listed for particular components are based on the final weight of the composition when applied as a solid coating, as opposed to the portion of a solution containing the composition prior to application on a wood product.

### Latex Binder

The latex acts as a binder for the other materials in the composition, and in some cases is a continuous phase. It binds the materials together and adheres them to the wooden substrate. Because latexes are waterborne they offer health and environmental benefits compared to solvent borne or two component urethanes. This allows for all of the solid fire retardant materials to be dispersed with all of the liquid. In a two component polyurethane system all of the solid fire retardant materials are dispersed in the polyol side of the formulation which makes it more viscous and difficult to spray or pump. A latex binder also is not reactive to water. In a two component polyurethane system absorbed moisture on solid components can contribute to carbon dioxide formation and foaming problems during the curing of the coating. Latex binders are also often diluted with water. This increases the volume of the formulation but since the water evaporates it does not become part of the cured coating. This reduces the solid component/binder ratio. Since the binder is an organic polymer it will burn without additional fire retardants, keeping the amount of binder to a minimum improves fire performance.

There are many latex binders suitable for use with the disclosed embodiments. Representative latex binders include emulsion polymers comprised of addition polymer micelles dispersed in a continuous water phase. Typically, the latex system contains surfactants which serve to improve the phase stability of the emulsion. The polymer is made by free radical polymerization of unsaturated monomers, which may include but are not limited to, acrylic acid, acrylic esters, styrene, butadiene, methacrylic acid, methacrylate esters, and/or acrylonitrile. Commonly, small amounts of free radical initiators are added to the monomers at the beginning of the polymerization process. These emulsion polymers can be alkaline or acidic.

Specific examples of latex binders include polyacrylics, such as Raycryl 1020 and Raycryl 1001, manufactured by Specialty Polymers, Inc; and Rovene 4021 manufactured by Mallard Creek Polymers, Inc. These are typically mixed with water, thickeners and viscosity modifying agents.

In one embodiment the latex binder is an acrylic latex. In one embodiment, the latex binder is present from 15% to 75% by weight. In one embodiment, the latex binder is present from 15% to 35% by weight. In one embodiment, the latex binder is present from 20% to 30% by weight.

### Intumescent Component

The disclosed compositions also include an intumescent component, which improves endurance. Typical pressure treated lumber actually has decreased endurance when exposed to flame. However, the present embodiments include an intumescent that improves endurance. Also the chemistry of traditional pressure treatment does degrade the endurance. The fact that there is no pressure when applying the formulations of invention leads to less degradation. Additionally, pressure treatment chemicals catalyze the hydrolysis of cellulose to decompose the wood. In one embodiment, the compositions do not decrease endurance of a wood product when applied, compared to a similar wood product without the composition applied.

Intumescent particles suitable for use with embodiments of the disclosure include expandable graphite, which is graphite that has been loaded with an acidic expansion agent (generally referred to as an “intercalant”) between the parallel planes of carbon that constitute the graphite structure. When the treated graphite is heated to a critical temperature the intercalant decomposes into gaseous products and causes the graphite to undergo substantial volumetric expansion. Manufacturers of expandable graphite include GrafTech International Holding Incorporated (Parma, Ohio). Specific expandable graphite products from GrafTech include those known as Grafguard® 160-50, Grafguard® 220-50 and Grafguard® 160-80. Other manufacturers of expandable graphite include HP Materials Solutions, Incorporated (Woodland Hills, Calif.). Further, other types of intumescent particles known to a person of ordinary skill in the art would be suitable for use with embodiments of the disclosure.

In one embodiment, the intumescent particles are present from 1% to 30% by weight. In one embodiment, the intumescent particles are present from 10% to 20% by weight.

### Borate Component

The borate compound can perform several functions. Not wishing to be bound by theory, it is proposed that the borate compound has the following effects. First during combustion it can form boric acid which changes the pathway that wood and polymeric binders break down. With boric acid when wood and polymers break down they form more char and fewer combustible gasses thus reducing the amount of flames and the heat produced during a fire event. Some borate compounds also contain bound moisture which is released during a fire event. The release of the moisture reduces temperatures as the water vaporizes and the water vapor dilutes any combustible gasses that are generated during the combustion process making it more difficult to form a flammable gas mixture. This reduces flaming combustion, time to ignition, and the amount of heat released as the coating thermally decomposes.

There are several borate compounds suitable for use in the provided embodiments. Representative borate compounds include: Sodium borate, zinc borate (ZB), disodium octaborate tetrahydrate (DOT), ammonium pentaborate, potassium pentaborate, borates of magnesium, potassium tetraborate, boric oxide and boric acids. Examples of zinc borate include Firebreak® 415, Firebreak® 500 and Firebreak® ZB manufactured by Rio Tinto Minerals. An example of sodium borate is Neobor® manufactured by Rio Tinto Minerals. An example of boric acid is Optibor® manufactured by Rio Tinto Minerals. Examples of disodium octaborate tetrahydrate are Polybor® manufactured by Rio Tinto Minerals and Tim-Bor® distributed by Nisus Corporation. In one embodiment, the borate component is disodium octaborate tetrahydrate (DOT) which is present in the quantity ranging from about 10% to 70% of the dried coating.

In one embodiment, the borate compound is selected from the group consisting of sodium borate, zinc borate, disodium octaborate tetrahydrate, ammonium pentaborate, potassium pentaborate, potassium tetraborate, boric oxide, boric acids, hydrated calcium borate hydroxide (colemanite), hydrated sodium calcium borate hydroxide (ulexite), and combinations thereof.

In one embodiment, the borate compound is present from 5% to 70% by weight. In one embodiment, the borate compound is present from 10% to 45% by weight. In one embodiment, the borate compound is present from 15% to 40% by weight.

### Isocyanate Component

The compositions include an isocyanate component. The isocyanate component provides water resistance to a wood product onto which a coating of the composition has been applied. While fire-resistant polyurethane coatings may include an isocyanate component as a precursor to the polyurethane, in certain embodiments, the isocyanate in the provided composition is not a prepolymer. In other embodiments, the isocyanate in the composition is a prepolymer. In certain embodiments, the isocyanate may react with other components of the composition to make polymers that are not polyurethanes.

Isocyanates can react with water to make ureas and with themselves and other components in the system to make isocyanurates, alophonates, biurets and some other compounds. Additionally, there are latexes that can be used that are specifically designed to react with isocyanates to create a polyurethane. However, any polyurethane would be a minor component compared to the other polymers in the system. In one embodiment, the polyurethane is at most 20% of the dried weight of the composition.

For example, in certain embodiments, the latex binder and the isocyanate react to polymerize. This is true for certain latexes, such as Roshield 3275, but not for others. The isocyanate can polymerize with moisture or other components in the system without reacting with the latex.

The isocyanate may be a single isocyanate or mixtures of such compounds. Aromatic isocyanates are preferred. Examples of isocyanates include multifunctional isocyanates having two or more isocyanate functional groups). These include toluene diisocyanate (TDI), monomeric methylene diphenyldiisocyanate (MDI), polymeric methylenediphenyldiisocyanate (pMDI), 1,5′-naphthalenediisocyanate, and prepolymers of the TDI or pMDI, which are typically made by reaction of the pMDI or TDI with less than stoichiometric amounts of multifunctional polyols.

In one embodiment, the isocyanate compound is selected from the group consisting of toluene diisocyanate (TDI), monomeric methylene diphenyldiisocyanate (MDI), polymeric methylenediphenyldiisocyanate (pMDI), 1,5′-naphthalenediisocyanate, prepolymers of TDI or pMDI, and combinations thereof.

In one embodiment, the isocyanate compound is present from 1% to 40% by weight. In one embodiment, the isocyanate compound is present from 5% to 30% by weight. In one embodiment, the isocyanate compound is present from 10% to 25% by weight.

### Other Components

In addition to the latex component, the borate component, the intumescent component, and the isocyanate component, the compositions according to embodiments of the disclosure may contain other additives. Additives that may be incorporated into the compositions to achieve beneficial effects include, but are not limited to, surfactants, wetting agents, opacifying agents, colorants, viscosifying agents, catalysts, preservatives, biocides, fillers, diluents, hydrated compounds, halogenated compounds, acids, bases, salts, melamine and other additives that might promote the production, storage, processing, application, function, cost and/or appearance of the composition as a coating for wood products.

One additive that may be particularly useful to incorporate into the composition is micron-sized silica, including fumed silica and precipitated silica. Fumed silica is generally produced by pyrolysis of silicon tetrachloride or from quartz sand vaporized in a 3000° C. electric arc. It is commercially available from the Cabot Corporation (Boston, Mass.) under the trade name Cab-O-Sil®. Precipitated silica is generally produced by addition of sulfuric acid to aqueous sodium silicate solutions. Precipitated silica is commercially available from Evonik Industries (Hanau-Wolfgang, Germany) under the trademark Sipernat®. The silica can be incorporated into the formulation at a level of 0.01% to 15% on a weight basis of the dried coating. The addition of micronized silica to the formulation may improve the toughness and durability of the coating after it has intumesced. Physical toughness may be beneficial because combustion events can involve fairly turbulent air currents. If a coating on a wood product intumesces during a fire and is too delicate in this expanded form, then it can be simply blown off of the wood product, which would compromise or eliminate its protective effect.

In one embodiment, the composition further comprises one or more additives, the one or more additives selected from the group consisting of: silica, surfactants, wetting agents, opacifying agents, colorants, viscosifying agents, catalysts, preservatives, biocides, fillers, diluents, hydrated compounds, halogenated compounds, acids, bases, salts, and melamine.

### Solutions of the Composition

The compositions provided herein may be applied from a solution. In one embodiment, the composition is formulated as a solution. The solution contains the components of the composition along with one or more suitable liquids. The solution includes solvated and/or suspended components of the composition.

Representative solvents include water or any liquid capable of properly solvating and/or suspending all of the components of the composition. In one embodiment, the solution is an aqueous solution.

In one embodiment, the solution is formulated to be applied to a wood product. In order to be applied to a wood product, the solution must be compatible with manual or machine-based application methods known to those of skill in the art. Particularly, the viscosity and concentration of the solution must be such that the composition can be applied to a surface of the wood product evenly and in a controlled amount such that the final, solid coating of the composition on the surface has the weight composition of each component as provided herein. Representative solutions are described further below in the EXAMPLES section.

### Application of Coating

Coatings of the composition according to embodiments of the disclosure may be applied to a number of different products. As a non-limiting example, such coatings may be applied to wood products. Generally, coatings according to embodiments of the disclosure are applied to one or more surfaces of a wood product. In certain embodiments, coatings may be applied to a portion of one or more surfaces of the wood product. In certain embodiments, entire surfaces, or the entire surface, of wood product may be covered. In certain embodiments, the fire-resistant coating covers approximately 50% to approximately 100% of the product's surface area.

In one embodiment, the composition is disposed on a surface of a wood product.

In one embodiment, the surface of the wood product with the composition is flame-spread resistant such that it would pass the E 2768 flame spread test.

In one embodiment, the wood product is selected from the group consisting of: I-joists, trusses, solid sawn lumber, parallel strand lumber (PSL), oriented strand board (OSB), oriented strand lumber (OSL), laminated veneer lumber (LVL), laminated strand lumber (LSL), particleboard, and medium density fiberboard (MDF).

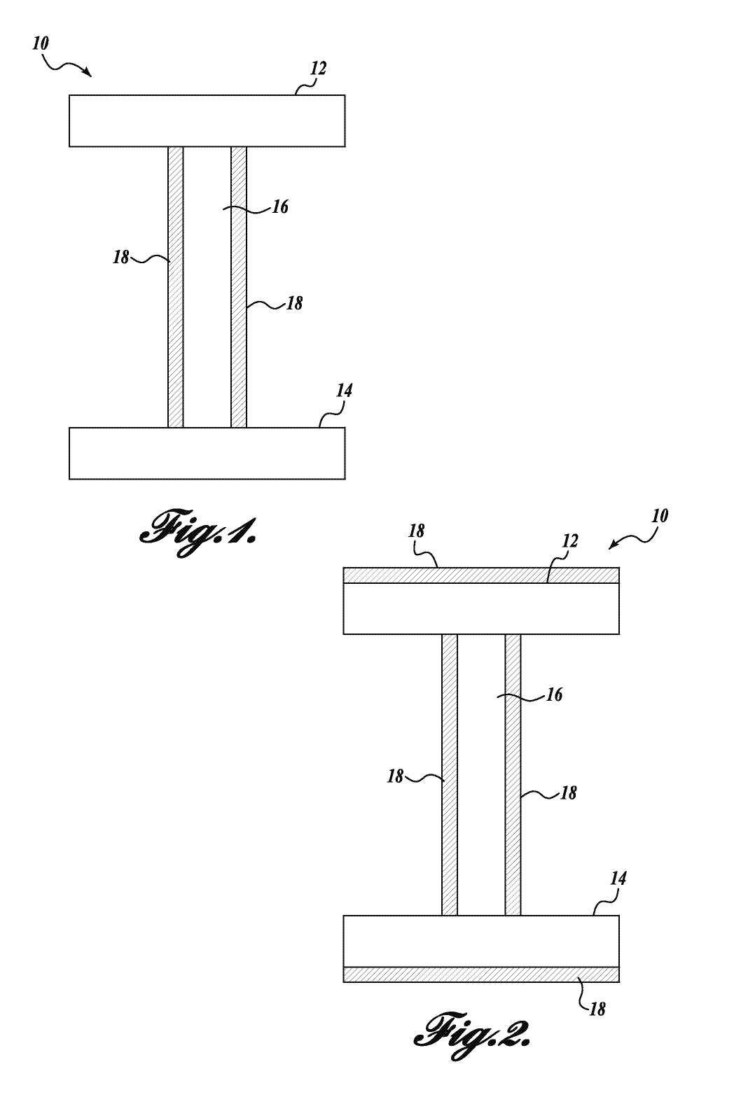

FIGS. 1-4 depict wood products having coatings of the compositions according to embodiments of the disclosure. FIGS. 1 and 2 show an I-joist 10 having a top flange 12, a bottom flange 14, and a webstock member 16 connecting the top flange 12 to the bottom flange 14. In FIG. 1, the webstock member 16 is shown completely coated in a coating 18 of a composition according to embodiments of the disclosure. Typically, any wood surface that is expected to be exposed to heat (e.g., fire) is coated. In certain embodiments, only a portion (e.g., 50% to 90%) of the webstock member 16 is coated. Although not explicitly shown in FIG. 1, some portion of overspray may be applied to the top flange 12 and/or the bottom flange 14.

Referring to FIG. 2, the I-joist 10 is shown in a state similar to that of FIG. 1, but also with, the top flange 12 and the bottom flange 14 coated with the composition according to embodiments of the disclosure. In certain embodiments, the coating covers 10% to 50% of the I-joist surface area. In other embodiments, the coating covers 51% to 100% of the I-joist surface area. A person of ordinary skill in the art will appreciate that numerous different application configurations for I-joists not shown explicitly in FIGS. 1 and 2 are within the scope of this disclosure.

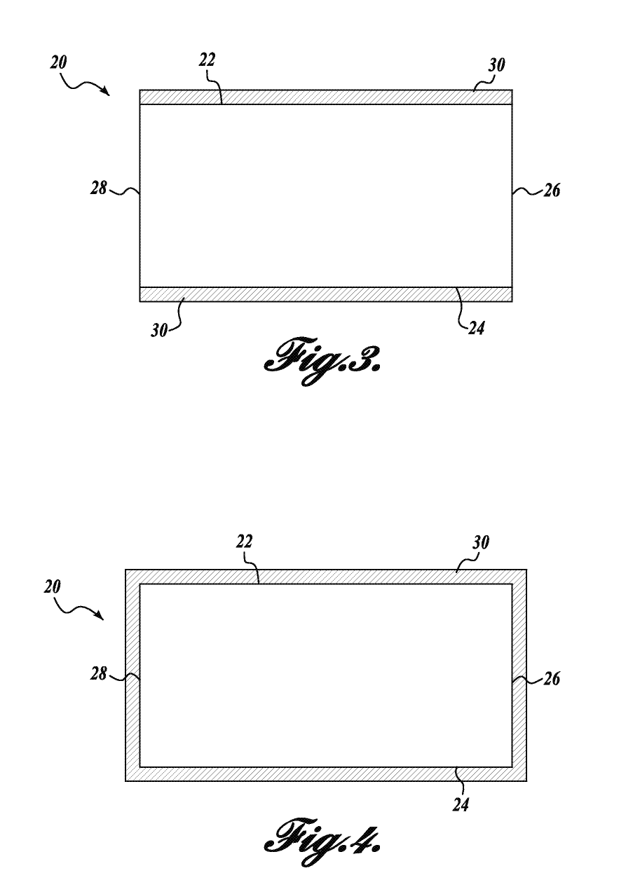

Referring to FIGS. 3 and 4, a wood element 20 is shown having a first surface 22, a second surface 24, a third surface 26, and a fourth surface 28. The wood element 20 may be any type of wood product, including but not limited to solid sawn lumber, parallel strand lumber (PSL), oriented strand board (OSB), oriented strand lumber, laminated veneer lumber (LVL), laminated strand lumber (LSL), particleboard, and medium density fiberboard (MDF). A person of ordinary skill in the art will appreciate that wood products according to this disclosure may have shapes other than those explicitly shown in the FIGURES.

Referring to FIG. 3, only the first surface 22 and the second surface 24 of the wood element 20 is coated with a coating 30 of a composition according to embodiments of the disclosure. The entire surfaces 22 and 24 may be coated or a portion may be coated.

In certain situations, it may be cost effective to coat only a portion of a surface of the wood element 20. For example, it is also possible that application of the coating 30 to a wood element 20 used as a building material could interfere with the ability of the wood element 20 to be connected or fastened, such as by nailing or screwing, to other building materials. In this situation, complete coverage of all of the exposed surface area on the wood element 20 may be undesirable.

Referring to FIG. 4, all four surfaces (the first surface 22, the second surface 24, the third surface 26, and the fourth surface 28) are coated with the coating 30. In certain situations, it may be desirable to cover each surface entirely or to cover only a portion of each surface. In certain embodiments, the coating 20 covers 10% to 50% of the wood element 20 surface area. In other embodiments, the coating 20 covers 51% to 100% of the wood element 20 surface area. A person of ordinary skill in the art will appreciate that numerous different application configurations for wood element 20 not shown explicitly in FIGS. 3 and 4 are within the scope of this disclosure.

It will also be appreciated that coatings made according to embodiments of the disclosure may be applied to different types of wood products other than those explicitly illustrated. For example, coatings may be applied to trusses or joists having any known configuration. In certain embodiments, wood products coated according to the disclosure include single sawn pieces of wood elements, or products having specific shapes. As a non-limiting example, coatings according to the disclosure may be applied to a variety of wood products (e.g., trusses) having a top flange, bottom flange, and one or more web stock members.

The application level of the coating may generally be in the range of 77.5 g/m² to 4650 g/m². In one embodiment, the level of coating is from 155 g/m² to 1550 g/m². In one embodiment, the level of coating is from 465 g/m² to 1085 g/m².

The preferred coating application level may depend on the element to which the coating is applied, the intended use, and performance requirements. In certain situations, minimal protection of the wood product might be needed and a relatively low spread rate may be suitable. In other situations (e.g., an exposed floor assembly), a higher application rate may be appropriate.

Coatings according to embodiments of the disclosure may be applied with any equipment known to those of skill in the art, such as spray systems, extruders, curtain coaters, and roll coaters, and other application equipment. In certain embodiments, coatings according to embodiments of the disclosure may be applied to any surface area described herein as a series of discrete beads using an extruder or another equivalent apparatus. Such beads may each be approximately ⅛ of an inch to approximately 1 inch in diameter and may be spaced so that they are approximately ⅛ of an inch to approximately ¼ of an inch apart.

In certain embodiments, the coating is applied manually with a hand-held knife or brush.

Although this disclosure explicitly describes applications of coatings to wood products, a person of ordinary skill in the art will appreciate that coatings made according to embodiments of the disclosure may be applied to different types of materials. As a non-limiting example, coatings of the provided compositions may be applied to other types of construction materials, including but not limited to wood/plastic composites, gypsum, steel (including light-gauge steel framing and steel beams and columns), aluminum (ducting), and concrete. Furthermore, coatings according to embodiments of the disclosure may be applied to surfaces other than constructions materials in any situation where the properties of the composition may be beneficial. Additionally, while the compositions have both low-flame spread properties, as well as water resistance, the compositions may be used in applications that require only one of those two properties.

Words in the above disclosure using the singular or plural number may also include the plural or singular number, respectively. For example, the term “wood element” could also apply to “wood elements.” Additionally, the words “herein,” “above,” “below” and words of similar import, when used in this application, shall refer to this application as a whole and not to any particular portions of this application. When the word “or” is used in reference to a list of two or more items, that word covers all of the following interpretations of the word: any of the items in the list, all of the items in the list, and any combination of the items in the list.

From the foregoing, it will be appreciated that the specific embodiments of the disclosure have been described herein for purposes of illustration, but that various modifications may be made without deviating from the disclosure. For example, the compositions according to the disclosure may be impregnated in wood products or may be applied in a manner that is not considered a coating. In addition, coatings according to the disclosure may be used for reasons other than their low flame-spread properties.

Aspects of the disclosure described in the context of particular embodiments may be combined or eliminated in other embodiments. For example, aspects of the disclosure related to I-joists may be combined with aspects of the disclosure related to other wood products. Further, while advantages associated with certain embodiments of the disclosure may have been described in the context of those embodiments, other embodiments may also exhibit such advantages, and not all embodiments need necessarily exhibit such advantages to fall within the scope of the disclosure. Accordingly, the invention is not limited except as by the appended claims.

The following examples will serve to illustrate aspects of the present disclosure. The examples are intended only as a means of illustration and should not be construed to limit the scope of the disclosure in any way. Those skilled in the art will recognize many variations that may be made without departing from the spirit of the disclosure.

### EXAMPLES

### Exemplary Coatings

Four exemplary coatings were prepared: Exemplary Coatings 1-4. The coatings were first prepared as a dispersion according to the formulation tables below. To prepare the solutions, water and disodium octaborate were mixed using a cowles blade at high speed for 10 minutes. Thickener (either 3% HEC solution, 50% ASE solution, xanthan gum) was then added and mixed using a cowles blade at high speed for 5 minutes. A latex was then added and mixed using the same cowles blade for 5 minutes. Biocide (if used) was then added and mixed for 3 minutes. Fumed silica was then added and the formulation was mixed using the cowles blade for 3 minutes. The intumescent particles were then added and mixed by hand. The isocyanate was then added and mixed by hand for 1 minute before applying to the specimen.

Exemplary Coating 1 (WE84-67)

| | | | Percent |
|---|---|---|---|
| | | Percent Mass | Mass in |
| | | in Wet | Final Dried |
| Component | Product | Formulation | Coating |
| Water | | 25.41 | 0 |
| Disodium octaborate | 50% Polybor ®/50% | 25.41 | 42.0 |
| tetra hydrate | Tim-bor ® | | |
| Associative | 50% solution | 0.51 | 0.4 |
| thickener | ASE-60 (Rohm and | | |
| | Haas) | | |
| Acrylic latex | RayCryl 1020 | 25.41 | 18.5 |
| Biocide | Proxel BZ plus | 0.07 | 0.1 |
| Fumed silica | Cab-O-Sil HTE-5 | 0.64 | 1.0 |
| Intumescent | Expandable graphite | 17.15 | 29.0 |
| particles | | | |
| Isocyanate | Rubinate 1840 | 5.4 | 9.0 |

Exemplary Coating 2 (WE84-70)

| | | Percent Mass | Percent Mass |
|---|---|---|---|
| | | in Wet | in Final Dried |
| Component | Product | Formulation | Coating |
| Water | | 19.48 | 0 |
| Disodium octaborate | Poly bor | 24.35 | 42.6 |
| tetra hydrate | | | |
| Xanthan Gum | Kelzan | 0.12 | 0.2 |
| 3% HEC Solution | | 9.74 | 0.5 |
| Acrylic latex | RayCryl 1020 | 24.35 | 18.3 |
| Fumed silica | Cab-O-Sil EH-5 | 0.61 | 1.1 |
| Intumescent | expandable graphite | 15.34 | 26.8 |
| particles | | | |
| Isocyanate | Rubinate 1840 | 6.0 | 10.5 |

Exemplary Coating 3 (WE84-71)

| | | | Percent |
|---|---|---|---|
| | | Percent Mass | Mass in |
| | | in Wet | Final Dried |
| Component | Product | Formulation | Coating |
| Water | | 18.53 | 0 |
| Silane | | 0.58 | 1.0 |
| Xanthan Gum | Kelzan | 0.12 | 0.2 |
| Disodium octaborate | Poly bor | 23.17 | 39.0 |
| tetrahydrate | | | |
| 3% HEC Solution | | 9.26 | 0.5 |
| Acrylic latex | RayCryl 1020 | 23.17 | 16.8 |
| Fumed silica | Cab-O-Sil EH-5 | 0.58 | 1.0 |
| Intumescent particles | Expandable graphite | 14.59 | 24.6 |
| Isocyanate | Rubinate 1840 | 10.0 | 16.9 |

Exemplary Coating 4 (WE84-72)

| | | | Percent |
|---|---|---|---|
| | | Percent Mass | Mass in |
| | | in Wet | Final Dried |
| Component | Product | Formulation | Coating |
| Water | | 18.65 | 0 |
| Xanthan Gum | Kelzan | 0.12 | 0.2 |
| Disodium octaborate | Poly bor | 23.32 | 32.2 |
| tetra hydrate | | | |
| 3% HEC Solution | | 9.33 | 0.4 |
| Acrylic latex | RayCryl 1020 | 23.32 | 32.3 |
| Fumed silica | Cab-O-Sil EH-5 | 0.57 | 0.8 |
| Intumescent particles | expandable graphite | 14.69 | 20.3 |
| Isocyanate | Rubinate 1840 | 10.0 | 13.8 |

For comparison, polyurethane analogs of the Exemplary Coatings were also prepared and tested (the representative formulation below is referred to as a “Comparative Coating 1”).

Comparative Coating 1

| | | Percent Mass | Percent Weight |
|---|---|---|---|
| | | in Wet | in Final Dried |
| Component | Product | Formulation | Coating |
| Castor Oil | | 13.0 | 13.0 |
| Aromatic diol | | 18.0 | 18.0 |
| Fumed silica | Cab-O-Sil EH-5 | 0.3 | 0.3 |
| Intumescent particles | expandable | 20.0 | 20.0 |
| | graphite | | |
| Isocyanate | | 37.0 | 37.0 |
| Other Components | | 11.7 | 11.7 |

Composite Wood Product Flame-Spread Test

TimberStrand® LSL Rim Board Flame-Spread Test.

Exemplary Coating 1 was applied to TimberStrand® rimboard at a spread rate of approximately 796.24 grams/m² and subjected to a full scale E84/E2768 surface burning test (flame spread).

A flame-spread index is determined in the E84 test. The building code classifies the flame-spread index into classes. There are A, B and C flame spread ratings. The building code also allows for the use of fire-retardant-treated wood. Fire-retardant-treated wood (International Building code Section 2303.2) also utilizes ASTM E84 but requires the specimen to be tested with a 20 minute extension. ASTM E2768 was created with this extension in mind to evaluate the ability of a product to limit the surface spread of flame when evaluated for 30 minutes (10 min. plus 20 min.).

The Exemplary Coatings passed the E2768 test and kept the flame front from spreading more than 8.5 feet along the surface of the coated TimberStrand® LSL rim board in a 30 minute time period, while the Comparative Coating 1 allowed the flame to spread past the 10.5 foot mark in less than 20 minutes.

OSB Flame-Spread Test.

Exemplary Compositions 1-4 were painted onto sections of OSB and tested in a laboratory flame spread screening test where the coating was heated to above 500° C. and was then exposed to the flame of a propane torch.

The Exemplary Coatings did not ignite and the flame traveled only 6 inches along the coated OSB. When the flame was removed the surface of the coatings the surface did not hold a flame.

When the Comparative Coating 1 was exposed to the same test, the surface of the coating ignited, the flame traveled 8″ in a short amount of time, and when the flame was removed the surface of the coatings remained on fire and there were visible flames.

24-Hour Soak Test.

A water soak test was performed on the Exemplary Coatings and the Comparative Coatings as follow.

An 8″×8″ specimen of OSB is coated with a coating and dried. The specimen with the dried coating is then submerged horizontally in the water so that one edge of the OSB specimen is just underneath the water and the other is approximately 8″ under the water. The specimen is left in the bucket for 24 hours. After the 24-hour time period the specimen is removed from the water and a tongue depressor is used to attempt to scrape the coating off of the specimen. The coating is given a rating of very easy, easy, medium, hard or very hard, indicating how difficult it is to rub the coating off of the OSB. This test is performed because wood products are often stored outdoors and the coating must still perform after weeks or months of storage.

An example of a coating that was very easy to rub off is a formulation referred to as Comparative Coating 2 (“WE84-118”), which is a latex-based formulation that includes no isocyanate. An example of a coating that was hard to rub off is Exemplary Coating 5 (“WE84-136”), which contains isocyanate.

Comparative Coating 2 (WE84-118)

| | | | Percent Mass |
|---|---|---|---|
| | | Percent Mass | in Final |
| | | in Wet | Dried |
| Component | Product | Formulation | Coating |
| Water | | 40.5. | 0 |
| Disodium octaborate | Poly bor | 28.3 | 47.5 |
| tetra hydrate | | | |
| Viscosity modifier | ASE 60 | 0.4 | 0.7 |
| Silane | | 0.5 | 0.9 |
| Self crosslinking | Joncryl 8383 (BASF) | 14.6 | 24.5 |
| acrylic latex solids | | | |
| Fumed silica | Cab-o-Sil EH-5 | 0.7 | 1.2 |
| Expandable graphite | | 15.0 | 25.2 |

Exemplary Coating 5 (WE84-136)

| | | Percent Mass | Percent Mass |
|---|---|---|---|
| | | in Wet | in Final Dried |
| Component | Product | Formulation | Coating |
| Water | | 24.68 | 0 |
| Disodium octaborate | Poly bor | 19.7 | 26.2 |
| tetra hydrate | | | |
| Titanium dioxide | CR 8-22 | 9.8 | 13 |
| Viscosity Modifier | ASE 60 | 0.59 | 0.8 |
| Self cross linking | Encor 154S | 17.4 | 23.1 |
| latex solids | | | |
| Fumed silica | Cab-o-Sil EH-5 | 0.7 | 1.2 |
| Cab-o-Sil EH-5 | | 0.49 | 0.6 |
| Intumescent | Expandable graphite | 10.44 | 13.9 |
| particles | | | |
| Isocyanate | | 16.9 | 22.4 |

While illustrative embodiments have been illustrated and described, it will be appreciated that various changes can be made therein without departing from the spirit and scope of the invention.

The embodiments of the invention in which an exclusive property or privilege is claimed are defined as follows:

1. A composition having water resistance and low flame-spread, comprising:
a latex binder;
a borate compound;
intumescent particles; and
an isocyanate.

2. The composition of claim 1, wherein the latex binder is an acrylic latex.

3. The composition of claim 1, wherein the borate compound is selected from the group consisting of sodium borate, zinc borate, disodium octaborate tetrahydrate, ammonium pentaborate, potassium pentaborate, potassium tetraborate, boric oxide, boric acids, hydrated calcium borate hydroxide (colemanite), hydrated sodium calcium borate hydroxide (ulexite), and combinations thereof.

4. The composition of claim 1, wherein the isocyanate compound is selected from the group consisting of toluene diisocyanate (TDI), monomeric methylene diphenyldiisocyanate (MDI), polymeric methylenediphenyldiisocyanate (pMDI), 1,5′-naphthalenediisocyanate, prepolymers of TDI or pMDI, and combinations thereof.

5. The composition of claim 1, wherein the composition is disposed on a surface of a wood product.

6. The composition of claim 5, wherein the wood product is selected from the group consisting of I-joists, trusses, solid sawn lumber, parallel strand lumber (PSL), oriented strand board (OSB), oriented strand lumber (OSL), laminated veneer lumber (LVL), laminated strand lumber (LSL), particleboard, and medium density fiberboard (MDF).

7. The composition of claim 5, wherein the surface of the wood product with the composition is flame-spread resistant such that it would pass the E2768 flame spread test.

8. The composition of claim 1, wherein the latex binder is present from 15% to 75% by weight.

9. The composition of claim 1, wherein the latex binder is present from 15% to 35% by weight.

10. The composition of claim 1, wherein the borate compound is present from 10% to 70% by weight.

11. The composition of claim 1, wherein the borate compound is present from 5% to 45% by weight.

12. The composition of claim 1, wherein the intumescent particles are present from 1% to 30% by weight.

13. The composition of claim 1, wherein the intumescent particles are present from 15% to 25% by weight.

14. The composition of claim 1, wherein the isocyanate compound is present from 1% to 40% by weight.

15. The composition of claim 1, wherein the isocyanate compound is present from 5% to 30% by weight.

16. The composition of claim 1, wherein the composition is formulated as a solution.

17. The composition of claim 16, wherein the solution is formulated to be applied to a wood product.

18. The composition of claim 16, wherein the solution is an aqueous solution.

19. The composition of claim 1, further comprising one or more additives, the one or more additives selected from the group consisting of silica, surfactants, wetting agents, opacifying agents, colorants, viscosifying agents, catalysts, preservatives, biocides, fillers, diluents, hydrated compounds, halogenated compounds, acids, bases, salts, and melamine.

20. A wood product having water resistance and low flame spread, comprising:
a wood element having at least one surface; and
a composition according to claim 1 disposed on at least a portion of the at least one surface.
